(19) United States
(12) Patent Application Publication
(10) Pub. No.: US 2007/0013586 A1
(43) Pub. Date: Jan. 18, 2007

(54) Matching structure

(75) Inventor: Chi-Feng Hung, Hsin-Chu (TW)

Correspondence Address: TROXELL LAW OFFICE PLLC, SUITE 1404, 5205 LEESBURG PIKE, FALLS CHURCH, VA, 22041, US

(73) Assignee: Z-COM, INC.

(21) Appl. No.: 11/181,739

(22) Filed: Jul. 15, 2005

(51) Int. Cl. H01Q 1/24

(52) U.S. Cl. 343/702; 343/700 MS

(57) ABSTRACT

A matching structure is proposed in the present invention. The matching structure is attached to an antenna resonant body and formed with a U shape, an L shape or a hat shape to completely or partially cover one end of the antenna resonant body. Thereby, the matching structure provides electromagnetic coupling with the antenna resonant body to increase the resonance bandwidth. Thus, the resonance bandwidth meets various practical requirements of bandwidth.

### BACKGROUND OF THE INVENTION

1. Field of the Invention

The present invention is related to a matching structure, and more particularly, to a matching structure that is attached to an antenna resonant body for electromagnetic coupling and thereby increasing the resonance bandwidth.

2. Description of Related Art

With the progress of wireless communications, an antenna module used for wireless transmission and reception has become an important component for wireless devices. The antenna module has a variety of applications, such as wireless networks, mobile phones, Bluetooth communications, and is being developed to fulfill multi-frequency or wide bandwidth requirements.

Antennas have various structures, such as a multi-frequency antenna used for a portable electronic apparatus. FIG. 1 shows the antenna provided on a multi-layer printed circuit board (PCB) 10. The antenna has a radiating element 12 with an F-shape. The first conductive via 121 is connected to the conductive layer 14 of the PCB 10 and the second conductive via 122 is connected to the grounding metal layer 16. The crew holes 15 are used to fasten this antenna onto another apparatus. In addition, there are still other antenna structures, such as a reverse F-shaped structure, an antenna structure provided by a printed circuit or a planar antenna.

Except for the structures mentioned above, in order to increase the frequency band of antennas, the arrangements of inductances, capacitors and resistors are improved, and parasitic elements are added to change the electromagnetic fields surrounding the antennas to increase the bandwidth. For example, a chip antenna with an antenna body formed with a L-shaped or F-shaped conductive pattern is disclosed in U.S. patent. It has electromagnetic coupling with parasitic elements disposed thereon and can be applied for a wireless communication device, a wireless network or Bluetooth communication.

The present invention provides a matching structure, which has a novel matching structure attached to an antenna resonant body. The matching structure has an electromagnetic coupling relation with the antenna resonant body. Thereby, the resonance bandwidth is increased to meet the requirements of various applications.

### SUMMARY OF THE INVENTION

An objective of the present invention is to provide a matching structure, which is attached to an antenna resonant body and formed with a U shape, an L shape or a hat shape to completely or partially cover one end of the antenna resonant body. Thereby, the matching structure provides electromagnetic coupling with the antenna resonant body to increase the resonance bandwidth. Thus, the resonance bandwidth meets various practical bandwidth requirements.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional antenna provided on a PCB;

FIG. 2 is a schematic diagram of an antenna structure of a wireless network apparatus in accordance with the present invention;

FIG. 3 is a schematic diagram of an antenna structure of a cellular phone in accordance with the present invention;

FIG. 4A is a characteristic diagram of intensity versus frequency without disposition of the matching component in accordance with the present invention;

FIG. 4B is a characteristic diagram of intensity versus frequency with disposition of the matching component in accordance with the present invention;

FIGS. 5A-B show parameters of the matching structure in accordance with the present invention;

FIGS. 6A-E show several embodiments of the present invention; and

FIGS. 7A-D also show several embodiments of the present invention.

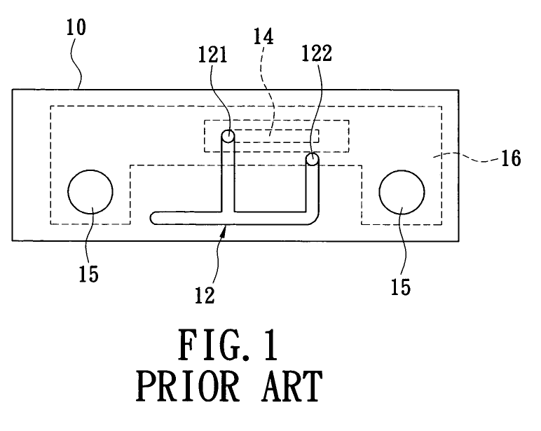

### DETAILED DESCRIPTION OF PREFERRED EMBODIMENTS

In order to effectively increase the frequency band of antennas, the electromagnetic effect of antennas was improved in the prior art via the modifications of the outward structures of antennas. The efficiency of the driving circuits of the antennas was also improved. For achieving the goal of effectively increasing the frequency band of antennas, the present invention provides a matching component arranged around the antenna resonant body to change the electromagnetic coupling conditions of antennas.

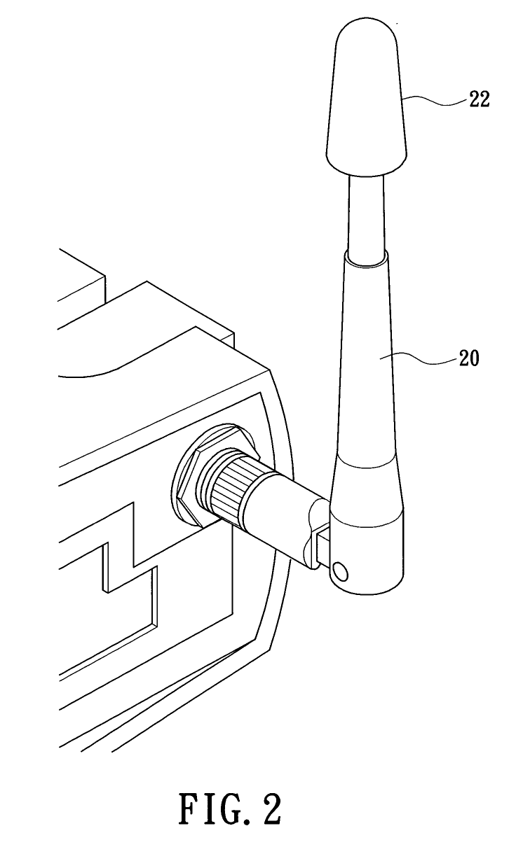

Reference is made to FIG. 2, which shows an embodiment of a matching structure, which is an antenna structure for wireless network equipment, in accordance with the present invention. The antenna resonant body 20 is coupled to a radio frequency (RF) module of wireless network equipment for transmission or reception of electromagnetic waves. Its structure is not limited to that shown in FIG. 2. One end of the antenna resonant body 20 has a hat-shaped matching component 22 attached thereto. The hat-shaped matching component 22 has a hollow structure and is made of metal. Via electromagnetic coupling with the antenna resonant body 20, the electromagnetic features of the antenna are changed to increase the frequency band. The hat-shaped matching component 22 can completely or partially cover the antenna resonant body 20 according to practical requirements.

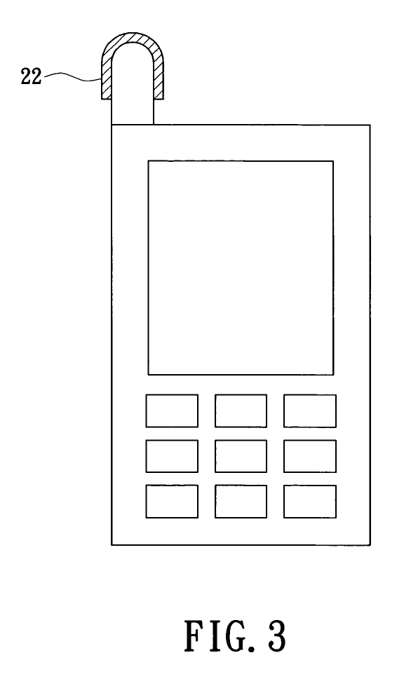

Reference is made to FIG. 3, which shows another embodiment of the present invention. The antenna 30 of a cellular phone also has a hat-shaped matching component 22 disposed thereon to change the electromagnetic features thereby increasing the frequency band.

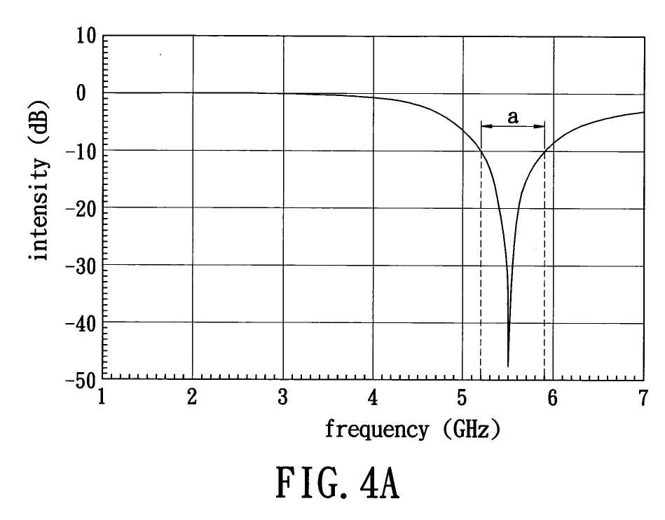

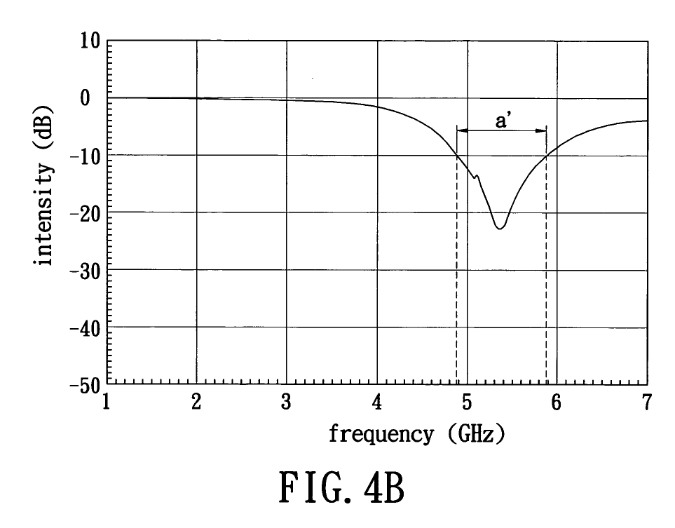

Reference is made to FIGS. 4A-B, which are diagrams respectively showing the intensity versus the frequency without and with the disposition of the matching component. As shown in FIG. 4A, when the intensity is −10 dB and the matching component is not provided, the bandwidth is about 0.9 GHz. As shown in FIG. 4B, when the intensity is −10 dB and the matching component is provided, the bandwidth a′ is about 1 GHz. Thus, these two figures prove that the matching component increases the bandwidth of antennas.

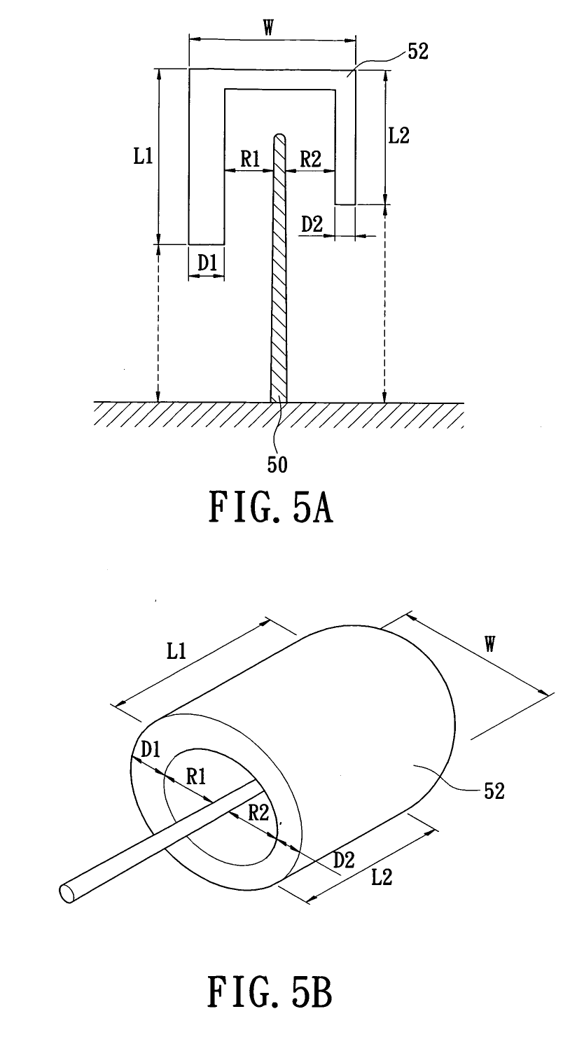

Reference is made to FIG. 5A, which shows the parameters of the matching component of the present invention that can be adjusted according to practical requirements. Reference is also made to FIG. 5B. The matching structure as shown in FIGS. 5A-B can be applied for unipolar, dipolar, multi-polar, PCB-type or other antenna structures for wireless communication. FIGS. 5A-B show a preferred embodiment having a U-shaped matching component 52 that covers one end of the antenna resonant body 50. The U-shaped matching component 52 can be attached via an adhesive material.

The adjustable parameters of the matching component 52 shown in FIG. 5A include, for example, the first length L1 and the second length L2 of the matching component 52. Adjusting the lengths L1 and L2 changes the structure of the matching component to a symmetric or asymmetric structure and thereby produces different electromagnetic coupling with the antenna resonant body. In FIG. 5B, the width W, such as the diameter of the matching component 52, can also be changed to produce different electromagnetic features of the matching component 52. Changing the first inner distance R1 or the second inner distance R2 between the matching component 52 and the antenna resonant body 50 changes the position of the matching component 52 relative to the antenna resonant body 50. Changing the first thickness D1 or the second thickness D2 also changes the spatial structure of the matching component 52. Via the change of the parameters mentioned above, the electromagnetic coupling relation between the matching component 52 and the antenna resonant body 50 is changed to adjust the electromagnetic features of the antenna resonant body 50 to fulfill various environmental requirements. The adjustable parameters are not limited to those mentioned above in the present invention. Various adjustable parameters of the matching component 52 can also be included.

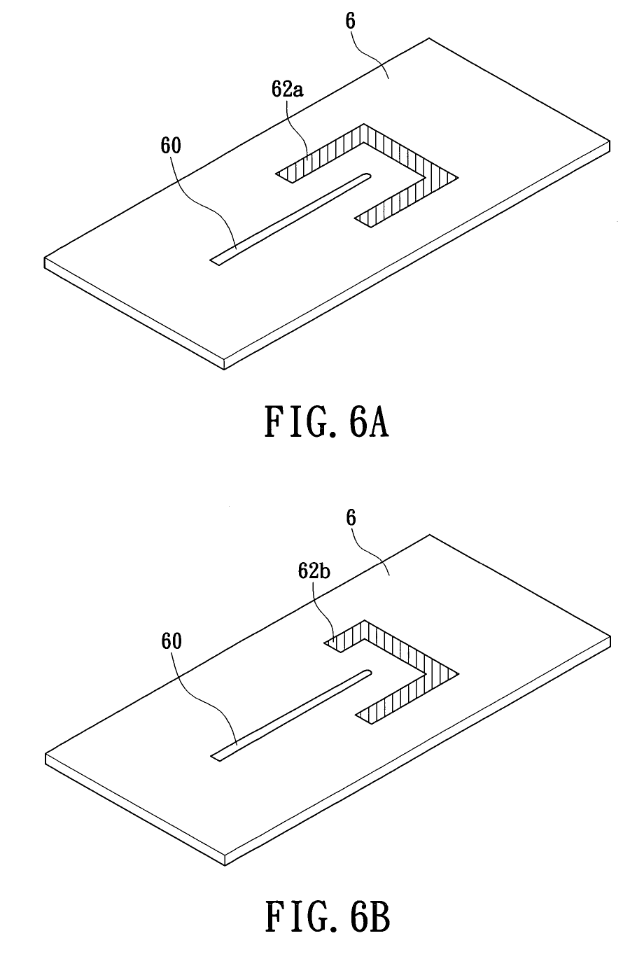

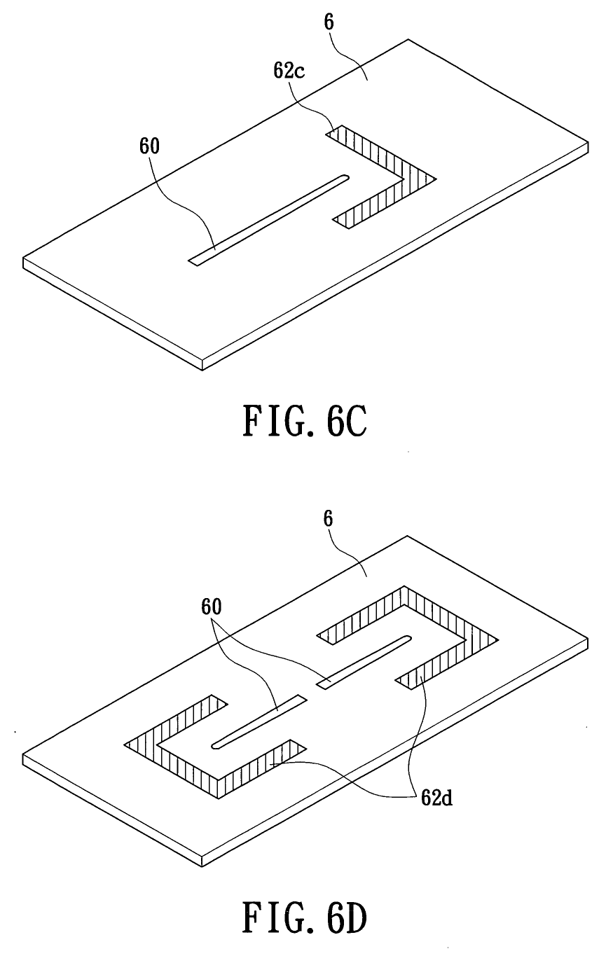

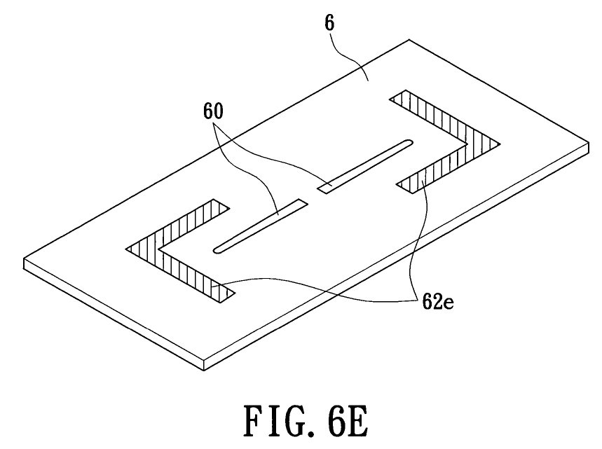

Reference is made to FIG. 6A, which shows a matching structure applied for a PCB in accordance with the present invention. The PCB 6 includes an antenna 60 and a matching component 62a. The matching component 62a is a matching structure made of a metal material and is disposed close to one end of the antenna 60. The matching component 62a is U-shaped and surrounds the antenna 60. Changing the physical structure, such as changing the parameters shown in FIG. 5A, adjusts the electromagnetic features of the antenna 60. The best embodiment can be used to meet the requirements of different designs.

FIG. 6B shows another embodiment of the U-shaped matching component, designated as 62b. Therein, the two arms of the matching component 62b have different lengths. FIG. 6C shows an L-shaped matching component 62c. Via the spatial change, the electromagnetic coupling effect of the antenna 60 is changed and thereby the usable frequency band is expanded.

FIG. 6D shows a dipolar antenna 60. Each of two opposite ends of the dipolar antenna 60 has a matching component 62d. The frequency band can be changed by adjusting the physical status of the matching component 62d. The present invention is not limited to the symmetric manner shown in FIG. 6D. Various combinations of U-shaped and L-shaped matching components can also be used to produce different electromagnetic effects, for example, the embodiment shown in FIG. 6E.

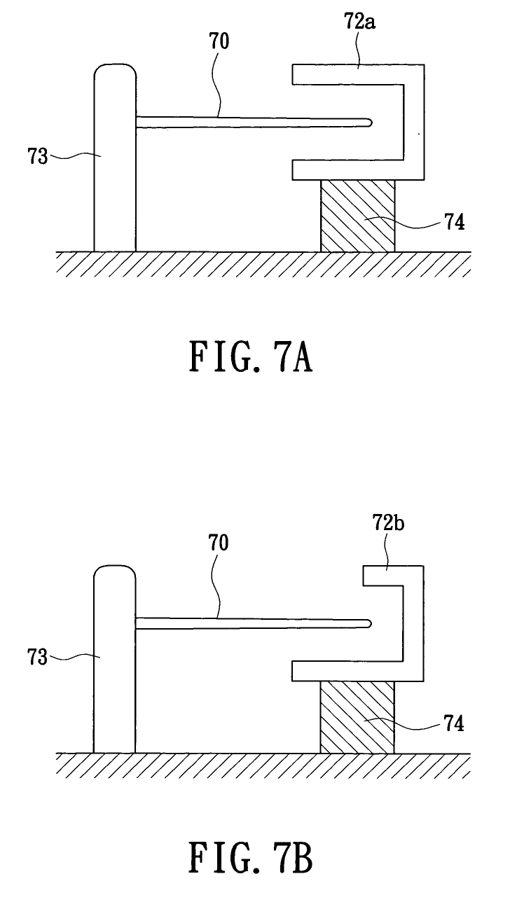

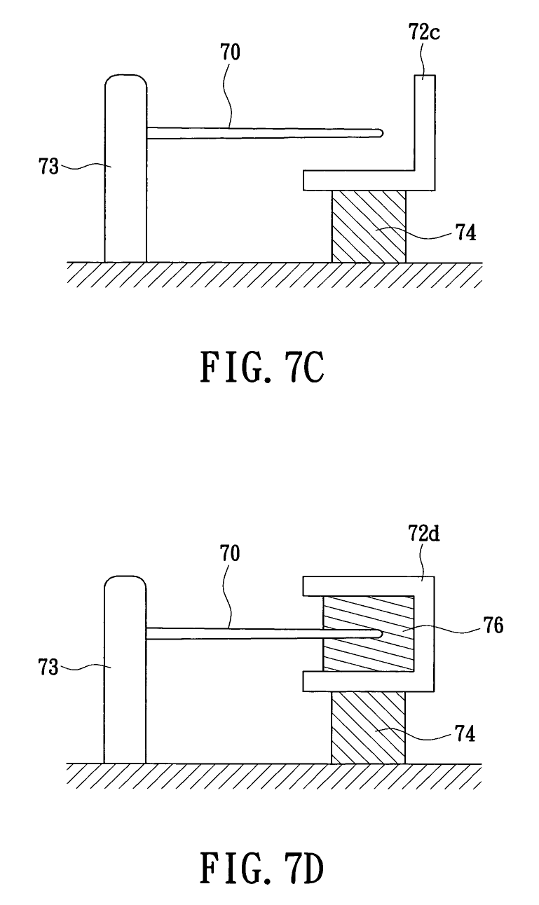

Reference is made to FIGS. 7A-D, which show another type of antenna in accordance with an embodiment of the present invention. As shown in FIG. 7A, the antenna 70 fixed on the first supporting structure 73 is suspended in the air. One end of the antenna 70 is surrounded by a matching component 72a that is made of a metal material and U-shaped. The matching component 72a can also be hat-shaped. The matching component 72a is fixed via the second supporting structure 14 as shown in FIG. 7A. The matching component 72a can also be fixed in other ways. The matching structure located at one end of the antenna 70 can be changed according to practical requirements for changing the electromagnetic effects nearby.

FIG. 7B shows a matching component 72b having an asymmetric U-shaped structure. FIG. 7C shows an L-shaped matching structure fixed on the second supporting structure 74. FIG. 7D shows a matching component 72d covering one end of the antenna 70 and a matching intermedium 76 provided between the hatching component 72d and the antenna 70. The matching intermedium 76 is used to fasten the structure shown in FIG. 7D. Furthermore, the antenna 70 is coupled with the matching component 72d via the matching intermedium 76 and its physical properties are changed thereby. In the embodiment shown in FIG. 7D, the frequency band of the antenna is changed not only via the structural modification of the matching component 72d , but also by the replacement of the material of the matching intermedium 76. The frequency band can be changed according to practical requirements.

In the embodiments mentioned above, via the change of the physical status of the matching structure, the electromagnetic coupling with the antenna resonant body is changed. Thus, the bandwidth of resonance is increased to fulfill various operative requirements. The drawings mentioned and shown above are used just for reference, but not for limiting the present invention.

To sum up, the matching structure of the present invention is attached to an antenna resonant body and formed with a U shape, an L shape or a hat shape to completely or partially cover one end of the antenna resonant body. Thereby, the matching structure increases the resonance bandwidth.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A matching structure, comprising:
an antenna; and
a matching component disposed at one end of an antenna resonant body of the antenna to provide electromagnetic coupling with the antenna.

2. The matching structure as claimed in claim 1, wherein the matching component is made of a metal material.

3. The matching structure as claimed in claim 1, wherein the matching component is a symmetric or asymmetric U-shaped structure.

4. The matching structure as claimed in claim 1, wherein the matching component is an L-shaped structure.

5. The matching structure as claimed in claim 1, wherein the matching component is a hat-shaped structure.

6. The matching structure as claimed in claim 1, wherein the antenna is disposed on a printed circuit board (PCB).

7. The matching structure as claimed in claim 1, wherein the antenna is an antenna of a wireless communication apparatus.

8. The matching structure as claimed in claim 1, wherein the antenna is coupled with the matching component via a matching intermedium.

9. The matching structure as claimed in claim 1, wherein the matching component has parameters including a first length, a second length, a width, a first inner distance, a second inner distance, a first thickness and a second thickness.

10. A matching structure, comprising:
an antenna; and
a U-shaped matching component made of a metal material and disposed at one end of an antenna resonant body of the antenna to provide electromagnetic coupling with the antenna.

11. The matching structure as claimed in claim 10, wherein the U-shaped matching component is a symmetric or asymmetric U-shaped structure.

12. The matching structure as claimed in claim 10, wherein the antenna is disposed on a PCB.

13. The matching structure as claimed in claim 10, wherein the antenna is an antenna of a wireless communication apparatus.

14. The matching structure as claimed in claim 10, wherein the antenna is coupled with the U-shaped matching component via a matching intermedium.

15. The matching structure as claimed in claim 10, wherein the U-shaped matching component has parameters including a first length, a second length, a width, a first inner distance, a second inner distance, a first thickness and a second thickness.

16. A matching structure, comprising:
an antenna; and
a matching component made of a metal material, having a U shape, an L shape or a hat shape, and disposed at one end of an antenna resonant body of the antenna to provide electromagnetic coupling with the antenna.

17. The matching structure as claimed in claim 16, wherein the antenna is disposed on a PCB.

18. The matching structure as claimed in claim 16, wherein the antenna is an antenna for a wireless communication apparatus.

19. The matching structure as claimed in claim 16, wherein the antenna is coupled with the matching component via a matching intermedium.

20. The matching structure as claimed in claim 16, wherein the matching component has parameters including a first length, a second length, a width, a first inner distance, a second inner distance, a first thickness and a second thickness.
